(19) United States
(12) Patent Application Publication
(10) Pub. No.: US 2026/0136037 A1
(43) Pub. Date: May 14, 2026

(54) METHOD AND DEVICE FOR VIDEO CODING USING MULTIPLE BLOCKS-BASED INTRA TEMPLATE MATCHING PREDICTION

(71) Applicants: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(72) Inventors: Je Won Kang, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(21) Appl. No.: 19/118,619

(22) PCT Filed: Aug. 28, 2023
(86) PCT No.: PCT/KR2023/012712

§ 371 Date: Apr. 4, 2025

(30) Foreign Application Priority Data
Oct. 4, 2022 (KR) 10-2022-0126633
Aug. 24, 2023 (KR) 10-2023-0111332

(51) Int. Cl. H04N 19/51; H04N 19/159; H04N 19/176

(52) U.S. Cl. CPC H04N 19/51; H04N 19/159; H04N 19/176

(57) ABSTRACT

A method and an apparatus are disclosed for video coding using multiple blocks-based intra template matching prediction. A video decoding device establishes a search area for template matching and searches the search area based on a template of the current block to generate a plurality of candidate prediction blocks indexed according to an order of increasing template matching cost. The video decoding device obtains weights for the candidate prediction blocks and generates a prediction block of the current block by a weighted combination of one or more of the candidate prediction blocks using the weights.

### CROSS-REFERENCE TO RELATED APPLICATIONS

This is a U.S. national stage of Internation Application No. PCT/KR2023/012712 filed on Aug. 28, 2023, which claims priority to Korean Patent Application No. 10-2022-0126633 filed on Oct. 4, 2022, and Korean Patent Application No. 10-2023-0111332, filed on Aug. 24, 2023, the entire contents of each of which are incorporated herein by reference.

### TECHNICAL FIELD

The present disclosure relates to a video coding method and an apparatus using multiple blocks-based intra template matching prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Intra Template Matching Prediction (TMP) is an intra prediction mode that utilizes template matching, which searches for a prediction block within a search area to minimize a template matching cost and uses the corresponding block as a prediction block of a current block. The encoder signals the use of the intra TMP mode to the decoder, and the decoder performs the same prediction operation as the encoder. The decoder searches for a template with the minimum cost function value for the current template and uses the corresponding block of a searched template as the prediction block. Traditional intra TMP relies on a single prediction block, which hinders the improvement of prediction accuracy. Therefore, to enhance video encoding efficiency and particularly improve the quality of chroma components, it is necessary to consider methods for improving intra TMP.

### SUMMARY

The present disclosure seeks to provide a video coding method and an apparatus that search for the plurality of candidate prediction blocks using template matching and generate a prediction block of a current block from the plurality of searched candidate prediction blocks.

At least one aspect of the present disclosure provides a method for decoding a current block, performed by a video decoding device. The method includes establishing a search area for template matching. The method also includes searching the search area based on a template of the current block to generate a plurality of candidate prediction blocks indexed according to an order of increasing template matching cost and forming a set of the candidate prediction blocks. The method also includes obtaining weights for the candidate prediction blocks. The method also includes generating a prediction block of the current block by a weighted combination of one or more of the candidate prediction blocks using the weights. Another aspect of the present disclosure provides a method for encoding a current

block, performed by a video encoding device. The method includes establishing a search area for template matching. The method also includes searching the search area based on a template of the current block to generate a plurality of candidate prediction blocks indexed according to an order of increasing template matching cost and forming a set of the candidate prediction blocks. The method also includes obtaining weights for the candidate prediction blocks. The method also includes generating a first prediction block of the current block by a weighted combination of one or more of the candidate prediction blocks using the weights.

Yet another aspect of the present disclosure provides a computer-readable recording medium storing a bitstream generated by a video encoding method. The video encoding method includes establishing a search area for template matching. The video encoding method also includes searching the search area based on a template of a current block to generate a plurality of candidate prediction blocks indexed according to an order of increasing template matching cost and forming a set of the candidate prediction blocks. The video encoding method also includes obtaining weights for the candidate prediction blocks. The video encoding method also includes generating a first prediction block of the current block by a weighted combination of one or more of the candidate prediction blocks using the weights.

As described above, the present disclosure provides a video coding method and an apparatus that search for a plurality of candidate prediction blocks using template matching and generate a prediction block of a current block from the plurality of searched candidate prediction blocks. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 illustrates template matching prediction.

FIG. 7 illustrates intra template matching prediction.

FIG. 8 is a flow diagram illustrating a method for encoding a current block based on intra template matching prediction by a video encoding device according to one embodiment of the present disclosure.

FIG. 9 is a flow diagram illustrating a method for decoding a current block based on intra template matching prediction by a video decoding device according to one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

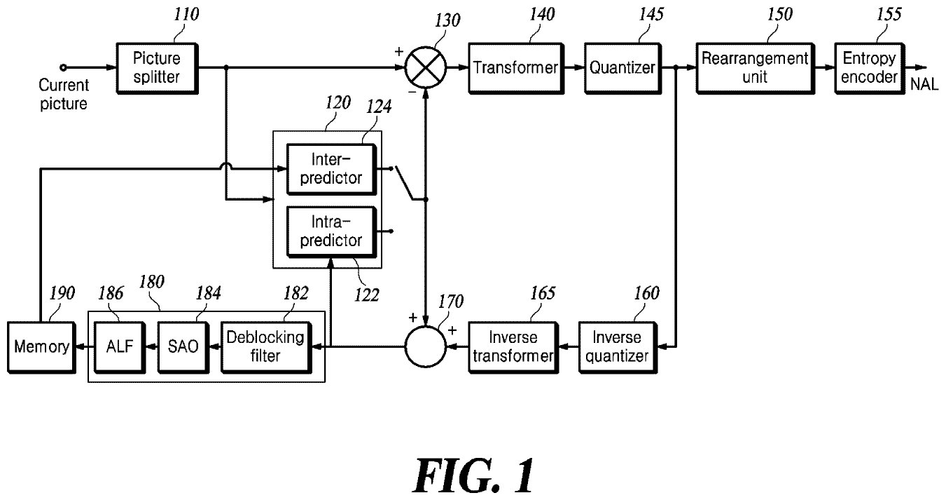

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

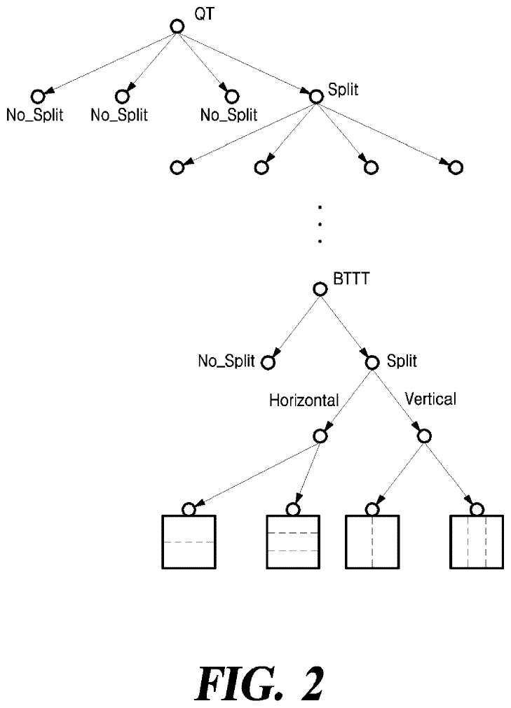

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

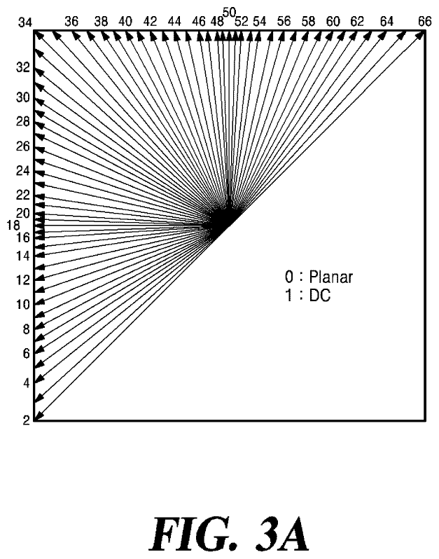

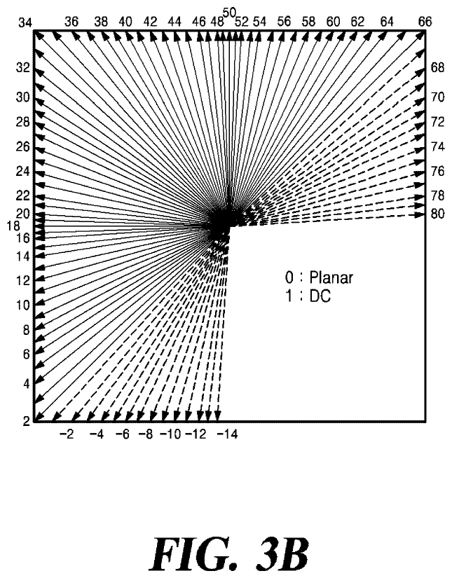

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable.

When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

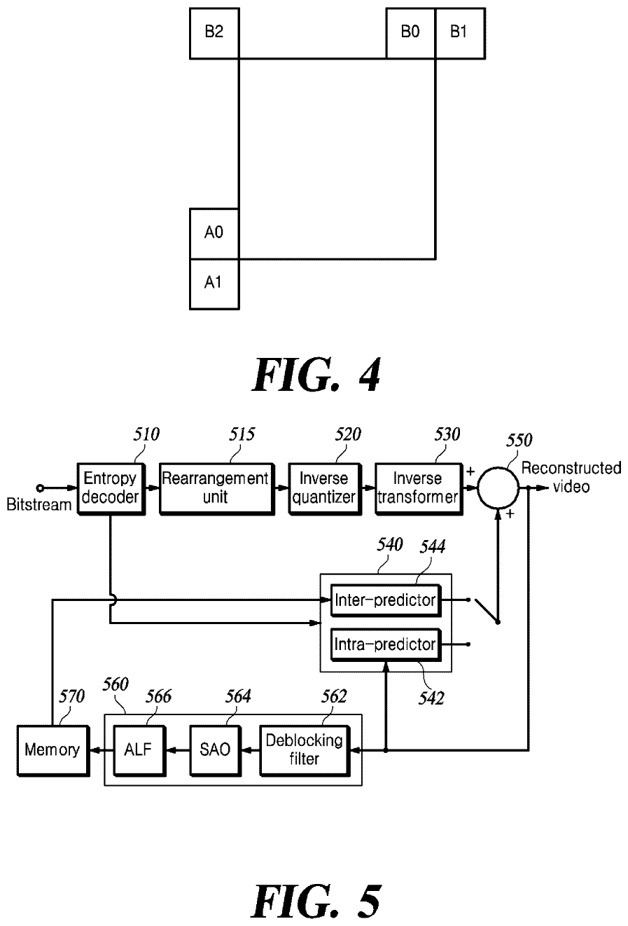

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block.

When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that search for a plurality of candidate prediction blocks using template matching and generate a prediction block of a current block from the plurality of searched candidate prediction blocks.

The following embodiments may be performed by the intra predictor 122 in the video encoding device. The following embodiments may also be performed by the intra predictor 542 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Intra Prediction Techniques

As described above, intra prediction is a method for predicting a current block by referencing samples present around a block to be encoded. In the VVC technique, the intra prediction modes for luma blocks include refined directional modes (i.e., 2 to 66) in addition to non-directional modes (i.e., planar and DC), as illustrated in FIG. 3A. Also, as additionally shown in the example in FIG. 3B, the intra prediction modes for luma blocks include directional modes (−14 to −1 and 67 to 80) based on wide-angle intra prediction (WAIP).

Also, intra prediction may utilize prediction techniques such as Multiple Reference Line intra Prediction (MRLP), Position Dependent intra Prediction Combination (PDPC), Intra Sub-Partitions (ISP), Matrix-based Intra Prediction (MIP), Most Probable Mode (MPM), and Template Matching Prediction (TMP).

In the intra prediction process utilizing MRLP, a video encoding/decoding device may use Multiple Reference Line (MRL) to employ additional reference lines. When MRL is applied, the video encoding/decoding device may perform intra prediction for the current block using two additional lines of samples appended to the top and left edges of the current block in addition to the original reference line. To select a reference line when MRL is applied, an index (mrl_idx) indicating the reference line may be signaled to the video decoding device.

Among intra prediction methods, one of the rule-based prediction methods is Position Dependent intra Prediction Combination (PDPC). In other words, a predictor may be generated based on predefined operations by utilizing the coding information of a target block for which intra prediction is performed and spatially adjacent neighboring pixels of the target block.

PDPC modifies prediction samples generated according to a specific intra prediction mode to create an intra predictor of the current block. Here, the specific intra prediction mode includes, among prediction modes illustrated in FIG. 3A, a planar mode, a DC mode, a horizontal mode (prediction mode 18), a vertical mode (prediction mode 50), a directional mode along a diagonal line in the downward-left direction (prediction mode 2) and its 15 neighboring directional modes, and a directional mode along a diagonal line in the upward-right direction (prediction mode 66) and its 15 neighboring directional modes.

In PDPC, pixel values of prediction samples of the current block, generated according to a specific intra prediction mode, may be adjusted using predefined weights and position information of neighboring pixels.

ISP technique splits the current block into smaller subblocks of equal size, sharing the same intra prediction mode across all subblocks while allowing a separate transform for each subblock. The block may be split in the horizontal or vertical direction.

Hereinafter, the larger block before splitting is referred to as the current block, and

each of the smaller split blocks is referred to as a subblock.

In splitting the current block horizontally or vertically, if the size of the current block is too small, encoding efficiency may decrease for the split subblocks, or subblocks may become smaller than the minimum unit required for transform, making transform impossible. To prevent such cases, the application of ISP may be restricted based on the size of the subblocks obtained after splitting. In other words, splitting may be applied when the number of pixels in the subblock after splitting is 16 or more. For example, if the size of a current block is 4×4, ISP is not applied. A block with a size of 4×8 or 8×4 may be split into two subblocks of the same shape and size, which is referred to as Half_Split. Blocks of other sizes may be split into four subblocks of the same shape and size, which is referred to as Quarter_Split.

Using the neighboring pixels of the current block for which intra prediction is performed and encoding information of the current block, a predictor may be generated based on predefined matrix operations. This rule-based prediction method is referred to as Matrix-based Intra Prediction (MIP).

MIP generates all or part of the intra predictor using predefined matrix operations. If only part of the predictor is generated, MIP may further perform interpolation for upsampling or upscaling using the partial predictor to generate the final intra prediction samples that match the size of the current block.

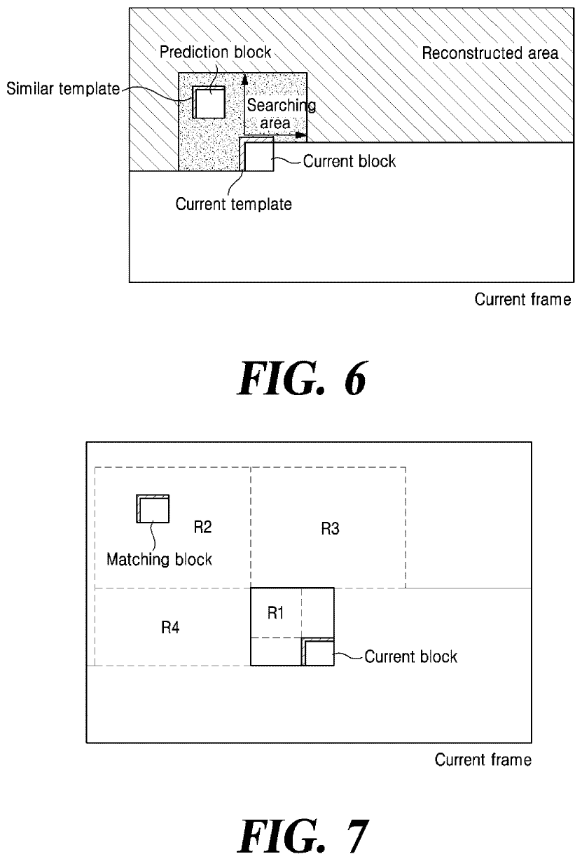

Template Matching Prediction (TMP) searches for the optimal prediction block that minimizes the difference between templates within a predefined search area in the current frame. Here, the predefined search area exists within the reconstructed area of the current frame. The current template consists of neighboring samples located above and to the left of the current block. As illustrated in FIG. 6, TMP searches for the optimal similar template within the search area and derives a prediction block (or “reference block”) corresponding to the searched optimal template. TMP utilizes a cost function that calculates the difference between the current template and the searched templates to search for a template that yields the minimum cost within the search area. At this time, Sum of Absolute Differences (SAD) is mainly used as the cost function for template matching. TMP determines the block corresponding to the template that yields the minimum cost as the prediction block for the current block.

Intra TMP is an intra prediction mode that utilizes template matching, which searches for a prediction block that yields the minimum template matching cost within a search area and uses the corresponding block as the prediction block of the current block. The video encoding device transmits a flag (hereinafter, referred to as the “template mode flag”) indicating whether to use intra TMP mode to the video decoding device. If the parsed flag is true, the video decoding device performs template matching-based prediction based on the same template as used in the video encoding device. The video decoding device searches for a template that yields the minimum of the cost function for the current template and uses the block corresponding to the searched template as the prediction block of the current block.

To reduce memory usage during template matching, Intra TMP may limit the search area to the current coding tree unit (CTU) where the current block is located, the upper-left

CTU, the upper CTU, and the left CTU. In the example of FIG. 7, the areas denoted as R1 (current CTU), R2 (upper-left CTU), R3 (upper CTU), and R4 (left CTU) represent the search area described above. Also, the search range within the search area may be adaptively determined by multiplying the height and width of the current block (BlkW, BlkH) by a predefined constant c. For example, by setting c=5, the search ranges SearchRange_w and SearchRange_h may be determined as shown in Equation 1.

$$\begin{matrix}SearchRange\_w = c \times BlkW \\ SearchRange\_h = c \times BlkH\end{matrix} \qquad [ Equation 1 ]$$

The MPM technique utilizes intra prediction modes of neighboring blocks during intra prediction of the current block. By transmitting the index of an MPM list instead of the index of a prediction mode, the video encoding device may improve the encoding efficiency of the intra prediction mode.

The Template-based Intra Mode Derivation (TIMD) method includes, after performing prediction for each intra prediction mode stored in the MPM list to generate predicted templates in the template region, calculating the cost between the pixels of the generated predicted template and the pixels of a previously reconstructed template. The TIMD method includes selecting two intra prediction modes as TIMD modes in order of ascending cost. After applying the PDPC process to the prediction blocks derived according to the two TIMD modes to generate filtered prediction blocks, the TIMD method may include applying weights to the filtered prediction blocks to construct the final intra prediction block.

The Decoder-side Intra Mode Derivation (DIMD) method includes calculating the gradient for each sample of neighboring samples around the current block and deriving a prediction mode for intra prediction of the current block from the calculated gradients. Unlike conventional methods where the intra prediction mode is encoded and transmitted to the decoder, the DIMD method enables the intra prediction mode to be derived on the decoder side.

Although the following embodiments are described with reference to the video decoding device, the embodiments may also be implemented in the video encoding device in the same way or similarly as implemented in the video decoding device.

### II. Embodiments According to the Present Disclosure

The intra TMP described above uses a single prediction block, which hinders the improvement of prediction accuracy. The intra TMP according to the present embodiment utilizes multiple candidate prediction blocks to enhance prediction accuracy.

The video decoding device constructs a plurality of candidate prediction blocks by searching a search area using template matching as described above. If the template matching cost between the template of each candidate prediction block and the template of the current block exceeds a predefined threshold, the video decoding device excludes the corresponding candidate from the set of candidate prediction blocks. When one or more blocks are used as prediction candidates, the video decoding device may generate the final prediction block by performing a weighted combination of the candidate prediction blocks. At this time, each weight used for the weighted combination may be determined based on the template matching cost. Meanwhile, if no block exhibits a template matching cost below the predefined threshold, the video decoding device may default to using a single prediction block according to the conventional method.

Hereinafter, embodiments of constructing a plurality of candidate prediction blocks using template matching are described.

The video decoding device establishes a search area to search for a plurality of candidate blocks and calculates the cost function values (i.e., template matching costs) of blocks within the search area using the conventional TMP method. The video decoding device forms a set B={B₁, B₂, . . . , B_{N}}, which consists of N (where N is a natural number) candidate blocks, B₁, B₂, . . . , B_{N}, arranged in the order of increasing template matching cost. In the set B, B₁ has the minimum cost, and the cost increases as the corresponding index increases.

If two candidate blocks exhibit the same cost while forming the set B, the video decoding device may follow one or a combination of the following methods to select one of the two candidate blocks.

The video decoding device may select the block that is first searched according to the TMP method between the two candidate blocks. The video decoding device may select the block closer to the current block. The video decoding device may select the block included in a CTU with a higher priority, where the priority is in the order of the current CTU, R2, R3, and R4. The video decoding device may average the two blocks with the same cost to generate a new block and may include the newly generated block in the set B in place of the two blocks.

Instead of utilizing all blocks included in the set B, the video decoding device may remove some blocks from the set based on template matching cost. Hereinafter, the template matching costs of candidate blocks B₁, B₂, . . . , B_{N} are defined as C₁, C₂, . . . , C_{N}, respectively. The video decoding device may directly use SAD according to the cost function as the cost C. Alternatively, the video decoding device may use the value generated by dividing SAD by the height, width, or size of the current block as the cost C. The video decoding device may remove candidate blocks using one of the following methods.

For example, if the cost value Cᵢ (where 1≤i≤N) exceeds a predefined threshold, the video decoding device removes all candidate blocks with indices greater than or equal to i from the set B.

In another example, if the difference between the cost values Cᵢ₋₁ and Cᵢ exceeds a predefined threshold, the video decoding device removes all candidate blocks with indices greater than or equal to i from the set B.

Depending on the embodiments, all candidate blocks except for a single block may be removed from the set B. In this case, the approach above is the same as the conventional intra TMP method, which utilizes a single prediction block.

In yet another example, instead of determining the number of candidate blocks based on template matching cost, the number of candidate blocks may be predefined according to an agreement between the video encoding device and the video decoding device. For example, N may be predefined as N=2.

Hereinafter, an embodiment of generating a prediction block of a current block using candidate prediction blocks is described.

Based on the candidate removal process described above, it is assumed that the set B contains M blocks (where 1≤M≤N). In other words, B={B₁, B₂, . . . , B_{M}}. Using one or more of the M blocks, the video decoding device may generate the prediction block P of the current block as shown Equation 2.

$$P = {w}_{1} {B}_{1} + {w}_{2} {B}_{2} + … + {w}_{M} {B}_{M} \qquad [ Equation 2 ]$$

Meanwhile, Equation 2 may be applied even without employing the candidate removal process (M=N).

In Equation 2, the weight wᵢ may be calculated according to one or a combination of the following methods.

The video decoding device calculates wᵢ using Cᵢ(1≤i≤M). For example, wᵢ is calculated as wᵢ=(C−Cᵢ)/((M−1)·C). Here, C is the sum of M values of Cᵢ.

The video decoding device may use a predefined constant wᵢ. For example, wᵢ may be set as wᵢ=1/M. In this case, the weights may be predefined according to an agreement between the video encoding device and the video decoding device.

The video encoding device may signal wᵢ to the video decoding device. After parsing wᵢ, the video decoding device may use the weight to generate the prediction block for the current block.

Some of the wᵢ (1≤i≤M) may be set to zero.

As described above, during the process of selecting a plurality of candidate blocks, if a template matching cost is larger than a threshold, the corresponding block is removed from the set B. Instead of using the removal process, template matching cost may be used in the process of generating a prediction block of the current block. For example, if the cost value C_{M+1} exceeds the threshold, the video decoding device may set the weights of all candidate blocks with indices greater than or equal to M+1 to zero. Also, the video decoding device may determine the weights of candidate blocks with indices less than or equal to M according to one of the following methods.

The video decoding device calculates wᵢ using Cᵢ(1≤i≤M). For example, wᵢ may be calculated as wᵢ=(C−Cᵢ)/((M−1)·C). Here, C is the sum of the costs of candidate blocks with indices less than or equal to M.

The video decoding device may use a predefined constant wᵢ. For example, wᵢ may be set as wᵢ=1/M. In this case, the weights may be predefined according to an agreement between the video encoding device and the video decoding device.

The video encoding device may signal wᵢ to the video decoding device. After parsing w_i, the video decoding device may use the weight to generate the prediction block for the current block.

Some of the wᵢ (1≤i≤M) may be set to zero.

Finally, the video decoding device may generate the prediction block of the current block according to Equation 2.

As described above, in selecting a plurality of candidate blocks, if the template matching cost exceeds a threshold, the corresponding block is removed from the set B. For example, instead of using the removal process, the video decoding device may generate a new candidate block by averaging the candidate blocks and may use the new candidate block. For example, if the cost value Cᵢ (where 1≤i≤N) exceeds a predefined threshold, the video decoding device may generate a new candidate block by averaging the candidate blocks with indices greater than i. Subsequently, the video decoding device may include the new candidate block in set B in place of the candidate blocks with indices greater than i. Alternatively, if the difference between the cost values Cᵢ₋₁ and Cᵢ is larger than a predefined threshold, the video decoding device may generate a new candidate block by averaging the candidate blocks with indices greater than i. Afterward, the video decoding device may include the new candidate block in set B in place of the candidate blocks with indices greater than i.

Meanwhile, for example, if no block exhibits a template matching cost below the predefined threshold, the video decoding device may configure Equation 2 using only the prediction block B₁, which exhibits the minimum template matching cost. This case is the same as the conventional intra TMP that uses a single prediction block.

According to the process described above, the video decoding device may select a plurality of candidate blocks and may use prediction blocks included in set B to generate a final prediction block. Hereinafter, a method for generating a final prediction block using both the prediction block searched based on template matching and a prediction block D, generated based on neighboring samples of the current block, is described. For example, the video decoding device may generate the prediction block D based on neighboring samples of the current block according to one or a combination of the following methods.

For example, the video decoding device may derive a prediction mode according to the DIMD method and may generate the prediction block D using the derived prediction mode.

In another example, the video decoding device may derive a prediction mode according to the TIMD method and may generate the prediction block D using the derived prediction mode.

In yet another example, the video decoding device may generate the prediction block D using conventional directional prediction modes or MIP technique.

Subsequently, the video decoding device may generate the final prediction block P as shown in Equation 3 by using the template matching-based prediction block B included in set B and the prediction block D generated using neighboring reference samples.

$$P = {w}_{1} B + ( 1 - {w}_{1} ) D \qquad [ Equation 3 ]$$

Here, weight w₁ may be determined according to one or a combination of the following methods.

The video decoding device may use a predefined constant wᵢ. For example, wᵢ may be set as wᵢ=½. In this case, the weights may be predefined according to an agreement between the video encoding device and the video decoding device.

The video encoding device may signal w₁ to the video decoding device. After parsing w₁, the video decoding device may use the weight to generate the prediction block for the current block.

The video encoding device may utilize the cost C of the prediction block B. For example, if the cost C exceeds a predefined threshold, the video encoding device may set w₁ to 0. On the other hand, if the cost C is less than or equal to the predefined threshold, the video encoding device may set w₁ to ½.

Although Eq. 2 is introduced for intra prediction in the present disclosure, Equation 2 may also be extended to inter prediction. After searching reference frames for a plurality of candidate blocks, the video decoding device constructs a set {B₁, B₂, . . . , B_{M}} consisting of N candidate blocks B₁, B₂, . . . , B_{N} according to the order of increasing matching cost. In the set B, the cost of B₁ is the minimum, and as the index i (1≤i≤N) increases, the corresponding cost also increases.

Similar to the approach expressed by Equation 2, the video decoding device may generate a prediction block using the weighted sum of candidate blocks. At this time, the video decoding device calculates wᵢ using Cᵢ. For example, wᵢ is calculated as wᵢ=(C−Cᵢ)/((N−1)·C). Here, C is the sum of N values of Cᵢ.

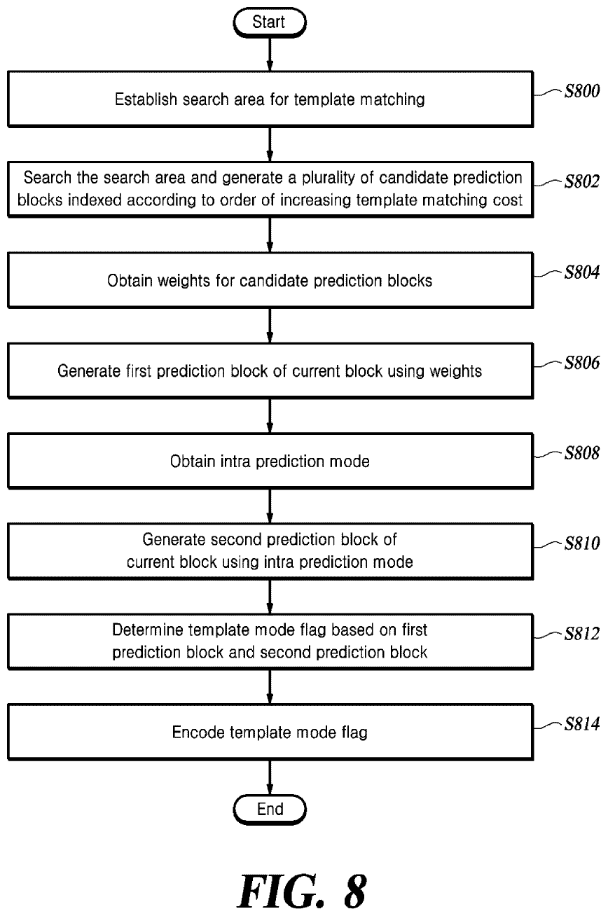

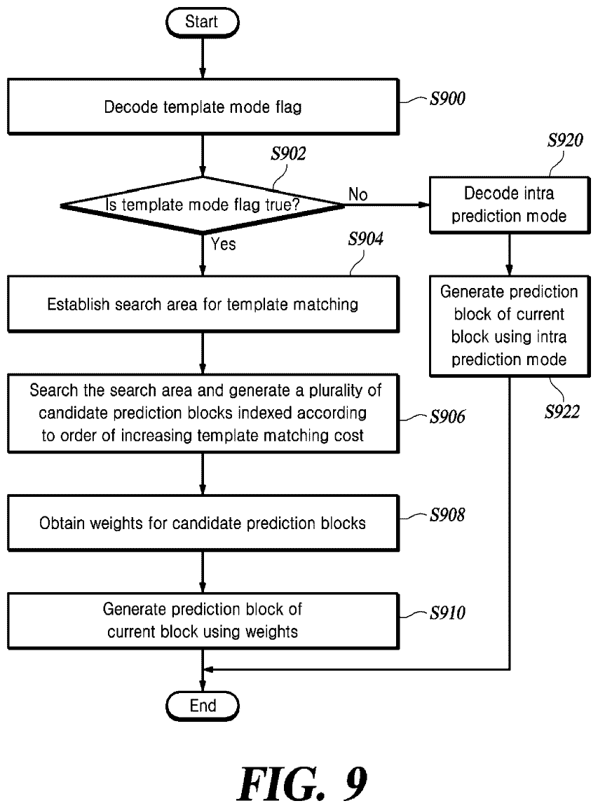

Hereinafter, a method for performing intra template matching prediction using a plurality of candidate prediction blocks is described with reference to FIGS. 8 and 9.

FIG. 8 is a flow diagram illustrating a method for encoding a current block based on intra template matching prediction by a video encoding device according to one embodiment of the present disclosure.

The video encoding device establishes a search area for template matching (S800).

The search area may be established within the reconstructed area of the current frame. To reduce memory usage during template matching, the video encoding device may establish the search area to include the current CTU, the upper-left CTU, the upper CTU, and the left CTU.

The video encoding device searches the search area based on the template of the current block to generate a plurality of candidate prediction blocks indexed according to the order of increasing template matching cost and forms a set of the candidate prediction blocks (S802).

If templates matching costs of two candidate prediction blocks are the same, the video encoding device may select one of the two blocks as follows. For example, the video decoding device may select the block that is first searched during the search process between the two candidate prediction blocks. The video encoding device may select the block closer to the current block from the two candidate prediction blocks. The video encoding device may select the block included in a CTU with a higher priority, where the priority is in the order of the current CTU, upper-left CTU, upper CTU, and left CTU. Also, the video encoding device may average the two candidate prediction blocks to generate a new block and may include the new block in the set of candidate prediction blocks in place of the two candidate prediction blocks.

The video encoding device may remove some blocks from the set of candidate prediction blocks based on template matching cost. At this time, the video encoding device may use the cost function value of each candidate prediction block as the template matching cost. Alternatively, the video encoding device may use the value generated by dividing the cost function value by the height, width, or size of the current block as the template matching cost.

For example, if the template matching cost of a candidate prediction block with index i exceeds a predefined threshold, the video encoding device may remove candidate prediction blocks with indices greater than or equal to i from the set of candidate prediction blocks.

In another example, if the difference between the template matching cost of a candidate prediction block with index i−1 and the template matching cost of a candidate prediction block with index i exceeds a predefined threshold, the video encoding device may remove candidate prediction blocks with indices greater than or equal to i from the set of candidate prediction blocks.

The video encoding device obtains weights for the candidate prediction blocks (S804).

The video encoding device may calculate the weight of each candidate prediction block based on the template matching cost of each candidate prediction block.

The video encoding device may use predefined weights as the weights for the respective candidate prediction blocks. At this time, the weights may be predefined according to an agreement between the video encoding device and the video decoding device.

Meanwhile, the video encoding device may obtain weights from a higher level. Subsequently, the video encoding device may signal the weights to the video decoding device.

The video encoding device generates a first prediction block of the current block by performing a weighted combination of one or more candidate prediction blocks using the weights (S806).

The video encoding device acquires an intra prediction mode (S808). Here, the intra prediction mode is a prediction mode that does not use template matching prediction, and for example, the video encoding device may acquire the intra prediction mode from a higher level.

The video encoding device generates a second prediction block of the current block using the intra prediction mode (S810).

The video encoding device determines the template mode flag based on the first prediction block and the second prediction block (S812). Here, the template mode flag indicates whether to use intra template matching prediction.

From the perspective of rate-distortion optimization, the video encoding device may compare the first prediction block and the second prediction block to determine the template mode flag. For example, if the first prediction block is optimal, the video encoding device may set the template mode flag to true. On the other hand, if the second prediction block is optimal, the video encoding device may set the template mode flag to false.

The video encoding device encodes the template mode flag (S814).

Subsequently, based on the template mode flag, the video encoding device generates residual signals by subtracting the first prediction block or the second prediction block from the current block. The video encoding device may generate a bitstream of the residual signals by quantizing, transforming, and entropy encoding the residual signals.

FIG. 9 is a flow diagram illustrating a method for decoding a current block based on intra template matching prediction by a video decoding device according to one embodiment of the present disclosure.

The video decoding device decodes the template mode flag from the bitstream (S900). Here, the template mode flag indicates whether to use intra-template matching prediction.

The video decoding device checks the template mode flag (S902).

If the template mode flag is true (Yes in S902), the video decoding device performs the following steps.

The video decoding device establishes a search area for template matching (S904).

The video decoding device searches the search area based on the template of the current block to generate a plurality of candidate prediction blocks indexed according to the order of increasing template matching cost and forms a set of the candidate prediction blocks (S906).

The video decoding device acquires weights for the candidate prediction blocks (S908).

The video decoding device may calculate the weight of each candidate prediction block based on the template matching cost of each candidate prediction block.

The video decoding device may use predefined weights as the weights for the candidate prediction blocks. Here, the weights may be predefined according to an agreement between the video encoding device and the video decoding device.

Meanwhile, the video decoding device may decode the weights from the bitstream.

The video decoding device generates a prediction block of the current block by weighted combination of one or more candidate prediction blocks using the weights (S910).

On the other hand, if the template mode flag is false (No in S902), the video decoding device performs the following steps.

The video decoding device decodes the intra prediction mode from the bitstream (S920). Here, the intra prediction mode is a prediction mode that does not use template matching prediction.

The video decoding device generates a prediction block of the current block using the intra prediction mode (S922).

Subsequently (after S910 or S922), the video decoding device may reconstruct the current block by decoding the residual signals and adding the decoded residual signals to the prediction block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

110: Picture splitter
122: Intra predictor
542: Intra predictor

1. A method for decoding a current block, performed by a video decoding device, the method comprising:
establishing a search area for template matching;
searching the search area based on a template of the current block to generate a plurality of candidate prediction blocks indexed according to an order of increasing template matching cost and forming a set of the candidate prediction blocks;
obtaining weights for the candidate prediction blocks; and
generating a prediction block of the current block by a weighted combination of one or more of the candidate prediction blocks using the weights.

2. The method of claim 1, further comprising:
decoding a template mode flag from a bitstream, wherein the template mode flag indicates whether to use intra template matching prediction; and
checking the template mode flag,
wherein, when the template mode flag is true,
establishing the search area to generating the prediction block are performed.

3. The method of claim 2, when the template mode flag is false, further comprising:
decoding an intra prediction mode that does not use the intra template matching prediction from the bitstream; and
generating a prediction block of the current block using the intra prediction mode.

4. The method of claim 1, wherein, when template matching costs of two candidate prediction blocks are the same, forming the set comprises:
selecting a block that is first searched during a search process between the two candidate prediction blocks.

5. The method of claim 1, wherein, when template matching costs of two candidate prediction blocks are the same, forming the set comprises:
averaging the two candidate prediction blocks to generate a new block and including the new block in the set of candidate prediction blocks in place of the two candidate prediction blocks.

6. The method of claim 1, wherein forming the set comprises:
removing some blocks from the set of candidate prediction blocks based on template matching cost,
wherein a cost function value of each candidate prediction block is used as the template matching cost, or a value generated by dividing the cost function value by height, width, or size of the current block is used as the template matching cost.

7. The method of claim 6, wherein, when template matching cost of a candidate prediction block with index i exceeds a predefined threshold, removing some blocks from the set of candidate prediction blocks comprises:
removing candidate prediction blocks with indices greater than or equal to i from the set of candidate prediction blocks.

8. The method of claim 6, wherein, when a difference between template matching cost of a candidate prediction block with index i−1 and template matching cost of a candidate prediction block with index i exceeds a predefined threshold, removing some blocks from the set of candidate prediction blocks comprises:
removing candidate prediction blocks with indices greater than or equal to i from the set of candidate prediction blocks.

9. The method of claim 1, wherein obtaining the weights comprises:
calculating weight of each candidate prediction block based on the template matching cost of each candidate prediction block or using predefined weight as the weight for each candidate prediction block.

10. The method of claim 1, wherein forming the set comprises:
generate a new candidate block by averaging the candidate prediction blocks based on the template matching cost; and
including the new candidate block in the set of candidate prediction blocks.

11. The method of claim 10, wherein, when template matching cost of a candidate prediction block with index i exceeds a predefined threshold, generating the new candidate block comprises:
generating the new candidate block by averaging candidate prediction blocks with indices greater than or equal to i.

12. The method of claim 10, wherein, when the difference between template matching cost of a candidate prediction block with index i−1 and template matching cost of a candidate prediction block with index i exceeds a predefined threshold, generating the new candidate block comprises:
generating the new candidate block by averaging candidate prediction blocks with indices greater than or equal to i.

13. A method for encoding a current block, performed by a video encoding device, the method comprising:
establishing a search area for template matching;
searching the search area based on a template of the current block to generate a plurality of candidate prediction blocks indexed according to an order of increasing template matching cost and forming a set of the candidate prediction blocks;
obtaining weights for the candidate prediction blocks; and
generating a first prediction block of the current block by a weighted combination of one or more of the candidate prediction blocks using the weights.

14. The method of claim 13, further comprising:
obtaining an intra prediction mode that does not use intra template matching prediction; and
generating a second prediction block of the current block using the intra prediction mode.

15. The method of claim 14, further including:
determining a template mode flag based on the first prediction block and the second prediction block, wherein the template mode flag indicates whether to use the intra template matching prediction; and
encoding the template mode flag.

16. A computer-readable recording medium storing a bitstream generated by a video encoding method, the video encoding method comprising:
establishing a search area for template matching;
searching the search area based on a template of a current block to generate a plurality of candidate prediction blocks indexed according to an order of increasing template matching cost and forming a set of the candidate prediction blocks;
obtaining weights for the candidate prediction blocks; and
generating a first prediction block of the current block by a weighted combination of one or more of the candidate prediction blocks using the weights.
